(19) United States
(12) Patent Application Publication
(10) Pub. No.: US 2015/0006216 A1
(43) Pub. Date: Jan. 1, 2015

(54) DYNAMIC EVENT TYPE ON CALENDARS

(71) Applicant: Avaya Inc., Basking Ridge, NJ (US)

(72) Inventors: Gene Uba, Broomfield, CO (US); Robert C. Steiner, Broomfield, CO (US)

(21) Appl. No.: 13/930,652

(22) Filed: Jun. 28, 2013

(51) Int. Cl. G06Q 10/10

(52) U.S. Cl. CPC G06Q 10/1093
USPC 705/7.18

(57) ABSTRACT

A contact center is provided with the ability to efficiently and effectively execute strategy rules by referencing and comparing schedules of contact center entities. The contact center includes a scheduling module configured to convert a textual calendar description of an entity into rich calendar information for that entity. The rich calendar information may include one or more values that define or describe an event type in the entity's textual calendar description and the one or more values may further be used in connection with making work item routing decisions in the contact center.

### FIELD OF THE DISCLOSURE

The present disclosure is generally directed toward communications and more specifically toward contact centers.

### BACKGROUND

Many entities (e.g., work, resources, services, sites, etc.) in a contact center are tied to some sort of calendar or schedule. For example, hours of operation, emergency hours, and holiday schedules are all forms of typical calendars that are consulted frequently in a contact center, especially by a work assignment engine. Operations such as looking up a resource's availability are expensive because the work assignment engine has to look at lists of calendars or call external systems to see if the current time is within the rules of each of those calendars.

### SUMMARY

In particular, embodiments of the present disclosure provide a mechanism for converting a calendar of an entity (e.g., work, resources, services, sites, etc.) from a textual calendar description stored in a database or a set of rules in an application (e.g., Microsoft Outlook®) into an in-memory representation of the calendar that is optimized for efficient look-ups and comparisons. In some embodiments, this in-memory representation may correspond to a calendar that is broken into a series of time segments of equal length, where each time segment is represented in memory as a single bit. For example, if an hour is broken into four (4) time segments of 15 minutes each, then a calendar window of one week could be represented as a continuous series of 224 (4*8*7) time segments. In memory, this series of time segments can be effectively implemented as a bitmap where each bit in the bitmap represents one time segment.

An example of a textual representation of a calendar is provided below:

```
Calendar MyCalendar valid[2012-01-01..2016-01-01]
{
    Open Monday..Friday [07:00:00..12:00:00, 13:00:00..17:00:00]
    Except
    {
    2012/06/02..2012/06/04 [08:00:00..12:00:00] “Reduced Hours”,
    2012-09-04  [10:00:00..12:00:00] “Labor Day”,
    2012-11-21  [08:00:00..12:00:00] “Thanksgiving”,
    2012-11-23  [05:00:00..07:00:00] “Thanksgiving
                    (Modified Hours)”,
    2012-11-24  [05:00:00..12:00:00, 13:00:00..23:00:00]
“Thanksgiving (Extended Hours)”,
    2012-12-31  [07:00:00..11:00:00] “New Year's Eve”,
    2012-04-06  [07:00:00..10:00:00]
    },
    Open  Saturday [10:00:00..14:00:00],
    Open  Saturday [05:00:00..18:00:00],
    Closed
    {
    Sunday,
    2012/06/02..2012/06/04,
    <Last Monday in May> “Memorial Day”,
    <Fourth Day in July> “Independence Day”,
    <First Monday in September> “Labor Day”,
    <Fourth Thursday in November> “Thanksgiving”,
    *-12-25 “Christmas”,
    <First Day in January> “New Year”,
    June..July “Building Construction”,
    <Last Day in February [17:30:00]>..<First Day in March
    [17:30:00]> “Passover”
    }
    }
```

Another aspect of the present disclosure is that each textual representation within a calendar clause described above (e.g., Open, Open with Exception, and Closed) can be “computed” (e.g., converted from a textual representation into a bit value) at an administrable interval (e.g., every night at midnight, every weekend, etc.) for an administrable length of time into the future (e.g., the calendar can be computed for the following hour, day, week, etc.). The computation or conversion of the textual calendar results in a bitmap stored in memory as an array of bits where each bit represents the ‘OR’ing of all the calendar clauses of an entity for a particular time segment. When a strategy rule executes and it analyzes the calendar of an entity to determine if the calendar is currently open or closed, the bit for the current time segment (e.g., in the bitmap) is returned as the answer to the query. Multiple computed calendars could be potentially OR'ed to yield an open or closed result for a combination of entities.

Another aspect of the present disclosure is to enable the scheduling module to predict when one or more entities will be available or unavailable by looking at the entity's bitmap one or more bits ahead of current time. This enables the scheduling module to predict when resources are leaving, for example, by looking one bit ahead in a calendar for a quick and easy lookup.

In short, embodiments of the present disclosure also enable a scheduling a module to convert the textual representation of an entity's calendar into a bitmap, thereby making the process of calendar look up and scheduling routines much more quick and efficient. Specifically, the time division calendar segmentation approach described herein provides tremendous savings on memory storage size and lookup performance.

Even when a contact center calendar contains schedule information for an agent (e.g., in textual or binary form), the depth of the schedule information should also be considered as relevant. In other words, embodiments of the present disclosure contemplate using values other than single bits to represent an agent's availability information for a given time segment. For example, a contact center agent can be available from 9:00 AM until 9:00 PM, but his or her costs go up after 5:00 PM, based on overtime pay. The current calendar of events indicate he or she can take calls during that interval but it does not give the added insight that if it is after 5:00 PM, this agent's cost or the associated networking costs with accessing this agent is more expensive. As a result, an “uninformed” system would make a less than optimal cost match to the agent. With embodiments of the proposed disclosure, a contact center can intelligently route a call to a messaging service or to a less expensive agent for a fraction of the cost rather than routing the call to an agent whose overall expense would be significantly higher.

Embodiments of the present disclosure leverage the concept of creating bitmaps to represent calendar information and, instead of using a bit vector, a multi-bit vector can return an integer value or an index into a dictionary of values or functions. This concept changes the view of a simple calendar object to a more sophisticated object that returns different types of values. These values can relate to currency (e.g., costs, perceived revenue, etc.), percentages, floating point, or integer values instead of a Boolean open/close value.

Embodiments of the present disclosure can apply to both front office and back office work. Thus, it should be appreciated that embodiments of the present disclosure are not simply limited to use in a contact center context. Moreover, embodiments of the present disclosure allow more power and flexibility than current scheduled events on calendars today. Of course, the improved calendar information can be used in target/goal based routing in a contact center, too. It may also be used to further enhance attribute/property association with work, agents, and/or contact center services. In short, embodiments of the present disclosure simplify applications by only requiring a single calendar value query rather than a detailed calendar lookup (e.g., SQL or more complicated database operations).

For example, an agent may be working from 9:00 AM to 9:00 PM, but his or her cost goes up after 5:00 PM because of overtime pay. With embodiments of the present disclosure, the agent's calendar can return the actual cost of the agent as a function of time. If the cost is greater than $0.00, this implies the agent is available and has an associated cost. This availability and cost information can then be used to compare other agent calendars for the least cost available agent to associate with incoming calls.

Another application can check if a call is worth routing during a particular time or not. A calendar containing scheduled connection costs as shown above can be checked with a simple pseudo command like: if (Calendar.IsLessThan($15)) route-to agent.

As can be appreciated, during the interval from 9:00 AM to 5:00 PM, it is feasible to route to any available agent, but during overtime, routing calls to the agents who have this calendar schedule are not cost effective. Calls should be sent to a messaging system or an agent not on overtime rather than connecting an expensive agent to calls.

Functions like ramps, sine waves, or step functions can be easily implemented to help manage target-based routing. For example, at the beginning of the day, the number of calls routed to an agent may be tempered to a few calls at most an hour, but by the end of the day, the number of calls per hour could be increased to 60 or more.

Another embodiment proposes the ability to create multiple events associated with the different return values in the calendars. For example, one calendar event could indicate when an agent is available, another calendar event could indicate when an agent costs are at one value, while another calendar event indicates when the agent costs are at a different value, etc. Another embodiment recursively initiates new calendar events, which in turn reschedule one or more events on the calendar. Another aspect of the present disclosure could return Event Type Values based on a function of other calendar parameters besides time. For example, the Event Type Value could be a function of “Location/Longitude,” “GMT Offset,” “DST mode,” etc.

By viewing calendar events as more than simple Boolean available/not available, but as a multi-value, multi-functional type, more sophisticated and optimized event mappings or associations can be implemented. The Return Event Type from a simple Boolean could be opened up to any type which could include currency, percentages, biorhythms, etc.

In accordance with at least some embodiments of the present disclosure, a method is provided which generally comprises:

receiving calendar description information for a first entity's calendar;

segmenting the first entity's calendar into a plurality of segments including a first time segment and a second time segment, wherein the plurality of segments span a calendar window;

identifying a first event in the first time segment;

determining a first value for the first event;

building a rich calendar for the first entity that includes each of the plurality of segments and the first value stored in association with the first time segment; and

storing the rich calendar for the first entity in a non-transitory computer-readable memory.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting relationships between contact center entities and a scheduling module in accordance with embodiments of the present disclosure;

FIG. 3 is a block diagram depicting converted calendar information in accordance with embodiments of the present disclosure;

FIG. 4 is a flow diagram depicting a calendar conversion process in accordance with embodiments of the present disclosure; and

FIG. 5 is a flow diagram depicting a scheduling process in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

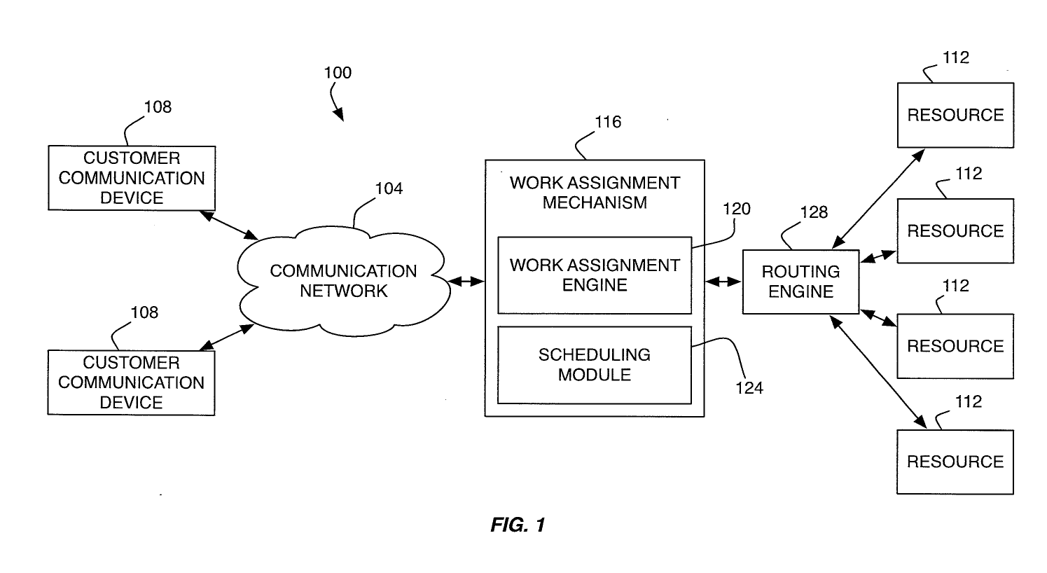

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 which initiated the communication with the assigned resource 112.

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 can determine which of the plurality of processing resources 112 is qualified and/or eligible to receive the work item and further determine which of the plurality of processing resources 112 is best suited to handle the processing needs of the work item. In situations of work item surplus, the work assignment engine 120 can also make the opposite determination (i.e., determine optimal assignment of a work item resource to a resource). In some embodiments, the work assignment engine 120 is configured to achieve true one-to-one matching by utilizing bitmaps/tables and other data structures.

In some embodiments, the work assignment engine 120 operates in concert with a scheduling module 124. The work assignment engine 120, as a part of making work assignment decisions, may need to determine whether a resource 112 is available, whether a work item is available, whether a contact center site is available, etc. In other words, each decision made by the work assignment engine 120 may require the work assignment engine 120 to analyze calendar information for multiple entities in the contact center. The scheduling module 124 provides a mechanism for building calendars and, in some embodiments, may also perform calendar or schedule analysis on behalf of the work assignment engine 120 (e.g., as a called function). In particular, the scheduling module 124 may be configured to determine event type information for every event of every entity in a contact center and build a new calendar that describes each entity's event types on a per-segment basis. The event type information can then be used by the work assignment engine 120 in connection with making work assignment decisions, for example. Thus, the rules executed by the work assignment engine 120 (e.g., match a work item to a best resource 112) may be assisted by the functionality of the scheduling module 124.

The work assignment engine 120 and/or the scheduling module 124 and their various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

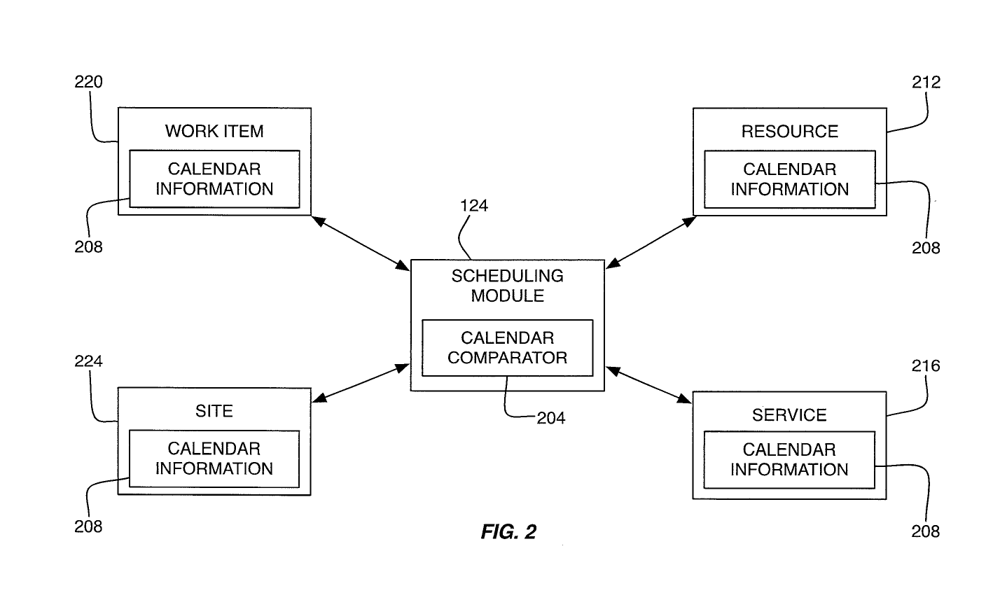

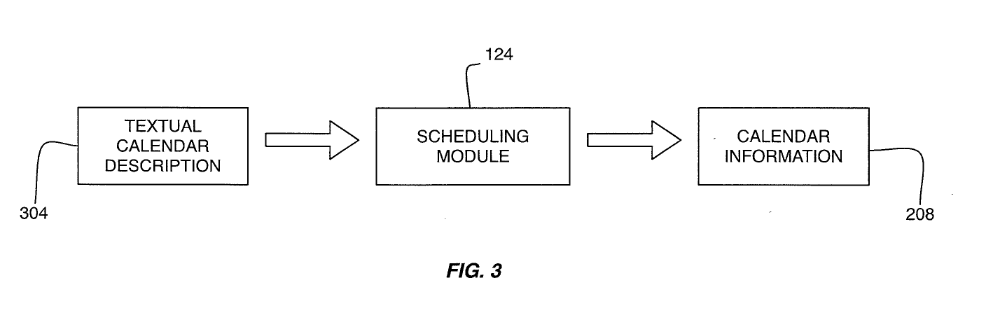

With reference now to FIGS. 2 and 3, additional functionality of the scheduling module 124 will be described in accordance with embodiments of the present disclosure. The scheduling module 124 may be configured to execute a number of functions in connection with providing calendaring and/or scheduling functions for use by the work assignment engine. Examples of such functions include, without limitation, the ability to compare calendar information 208 of a plurality of different entities in a contact center and the ability to generate calendar information 208 based on textual calendar description information, thereby making the analysis and/or comparison of calendar information 208 more efficient or effective by virtue of the fact that event type information is analyzed during the comparison of calendar information 208.

More specifically, the scheduling module 124 may be provided with a calendar comparator 204 that enables the scheduling module 124 to receive calendar information 208 from one or more of a resource 212 (e.g., similar or identical to resource 112), a service 216, a work item 220, and/or a contact center site 224. The calendar information 208 analyzed and compared by the calendar comparator 204 may be in the form of one or more multi-bit vectors that can return an integer value or an index into a dictionary of values or functions. Thus, the scheduling module 124 may be configured to execute the calendar comparator 204 against a number of different multi-bit vectors having event type values. The values contained in the calendar information 208 can relate to currency (e.g., costs, perceived revenue, etc.), percentages, floating point, or integer values instead of a Boolean open/close value.

As shown in FIG. 3, the calendar information 208 may be obtained by converting textual calendar description information 304 into rich calendar description information 208, where the rich calendar information 208 includes one or more values describing event type information and enabling routing on the one or more values. The conversion process performed by the scheduling module 124 may be done either continuously (e.g., every processing time period) or non-continuously on a periodic basis. When performed periodically, the amount of time between conversion or calculations may be on the order of minutes, hours, days, weeks, months, etc. Furthermore, the textual calendar description information 304 may be converted into rich calendar information for a calendar window (e.g., predetermined amount of time into the future, which may or may not include past time segments). More specifically, the textual calendar description information 304 may comprise an entity's schedule for any amount of time in the future (e.g., months, years, etc.), whereas the rich calendar information 208 may only correspond to a portion of that entity's schedule. The amount of time for which the rich calendar description information 208 is computed may be referred to as a calendar window. As can be appreciated, it may be desirable to compute a calendar window for an amount of time longer than the re-computing period. For example, if a calendar window is computed with a length of one day, then it may be desirable to re-compute the calendars of each entity in the contact center for an amount of time less than one day (e.g., every hour, every 12 hours, etc.). This ensures that up-to-date rich calendar description information 208 is computed on a useable basis.

In some embodiments, the conversion of a textual calendar description information 304 into rich calendar description information 208 may include analyzing a window of time within the textual calendar description information 304 for an entity, determining an event type or types for each event in the calendar description information 304, determining a value associated with each of the event types, and then assigning the determined value (representative of the event type) to a segment within the rich calendar description information 304. This can be performed for each segment of time being computed and for each entity in the contact center.

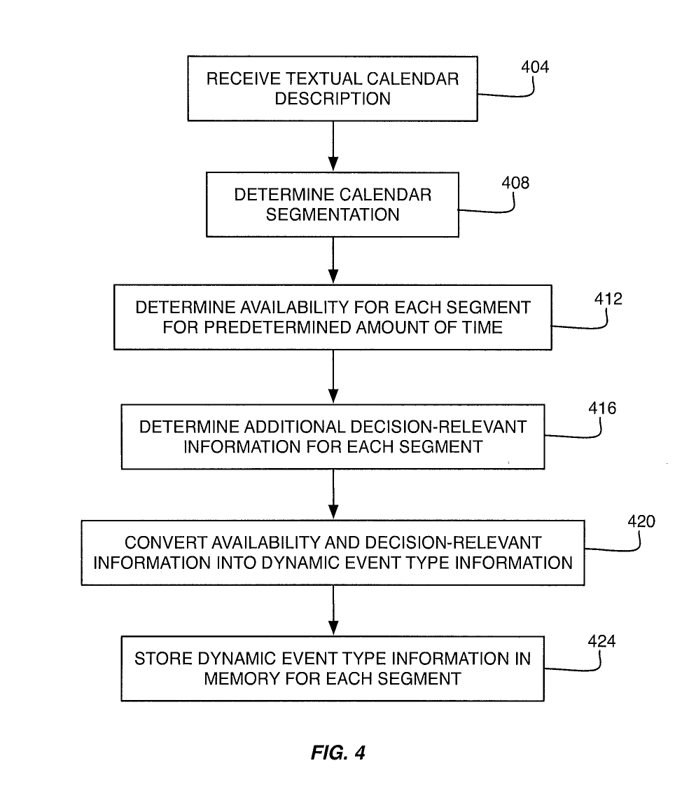

With reference now to FIG. 4, additional details of a process for converting a textual calendar description information 304 into rich calendar description information 208 will be described in accordance with embodiments of the present disclosure. The method begins when the scheduling module 124 receives the textual calendar description information 304 for an entity (e.g., a resource 212, service 216, work item 220, and/or site 224) (step 404). Although the examples described herein refer to a textual representation of calendar information, it should be appreciated that embodiments are not so limited. In particular, the “textual” representation may actually be in binary form (e.g., computer-readable form), but the eventual representation of that data may be formatted for text and/or graphical presentation to a user. Thus, it should be appreciated that “textual” as used herein may correspond to any traditional representation of a calendar. The actual state of the calendar data may be textual, ASCII text, other text, compiled data, un-compiled data, or the like.

Upon receiving the textual calendar description information 304, the scheduling module 124 then determines the desired calendar segmentation for the calendar information (step 408). The desired calendar segmentation may be defined by dividing a predetermined calendar window by a predetermined integer value. Alternatively, the number of segments and the amount of time represented by each segment may be predetermined and the calendar window may be a result of those predetermined values. As a non-limiting example, the scheduling module 124 may determine that twenty (20) segments are desired with each segment to represent fifteen (15) minutes. Thus, the resultant calendar window may correspond to approximately five (5) hours of time, where the full calendar window may be forward looking (e.g., in the future where time>t) or one or more of the segments may correspond to a current time segment (e.g., time=t) or a past time segment (e.g., time<t).

Once the desired calendar segmentation has been determined, the method continues with the scheduling module 124 determining the availability and/or unavailability of the entity for each segment in the calendar window (step 412). Specifically, the scheduling module 124 may analyze events within the entity's calendar to determine whether or not the entity is strictly available or strictly unavailable.

The scheduling module 124 then further analyzes the textual calendar description information 304 to determine, for each event therein, an event type or any other decision-relevant information for each event (step 416). Further still, the event type information for each event is correlated to a time segment. As can be appreciated, a single time segment may have more than one event, and each event may comprise a different event type and corresponding value, which is determined in step 420. The dynamic event type information stored in the calendar 208 of an entity may correspond to the values determined for an event type in the entity's textual calendar information 304.

As noted above, multiple event type values may be determined for a single time segment. Conversely, some segments may have no events therein. In some embodiments, the scheduling module 124 may correlate the lack of an event for a segment into a specific event type for the rich calendar information 208, where the event type has a specific value associated therewith (e.g., NO EVENT=routing cost of $0.00). Thus, the lack of an event in the entity's calendar may result in a value of zero being placed in the corresponding time segment since it can be presumed that the entity is otherwise available for routing purposes due to the lack of an event. The scheduling module 124 may also convert weekends, holidays, breaks, and the like into event types and determine a corresponding value, where the value depends on whether the entity can be interrupted from that event and, perhaps, any costs associated with such an interruption. If the event type is not interruptible, then the event type may be assigned a value of infinity or some very large value that will result in the entity not being considered during a work item routing decision. As noted above, this analysis is performed for each segment of time in the entity's textual calendar description information 304.

Once the analysis is complete and each event (or lack thereof) has been assigned a corresponding value, the scheduling module 124 builds and stores the rich calendar description information 208 for subsequent use and analysis (step 424). In some embodiments, each entity may have its own rich calendar information 208 that contains event type information stored in time segments. The event type information may include a bit, multiple bits, hexadecimal bits, and/or a multi-bit vector configured to return an integer value or an index into a dictionary of values or functions. The rich calendar information 208 is then stored in memory of a server, for example, where it can be used by the work assignment engine 120 in connection with making work assignment decisions and other decisions which require the analysis of calendar information for contact center entities. In some embodiments, the rich calendar information 208 may be stored in memory of a server that also hosts the work assignment mechanism 116. In other embodiments, some or all of the rich calendar information 208 for an entity may be stored in an external database; however, the use of an in-memory representation of the rich calendar information 208 may be preferred to facilitate quick calendar analysis operations by the work assignment engine 120.

As can be appreciated, the process of FIG. 4 may be repeated for every entity in the contact center every time the re-computation of rich calendar information 208 for the entities is desired.

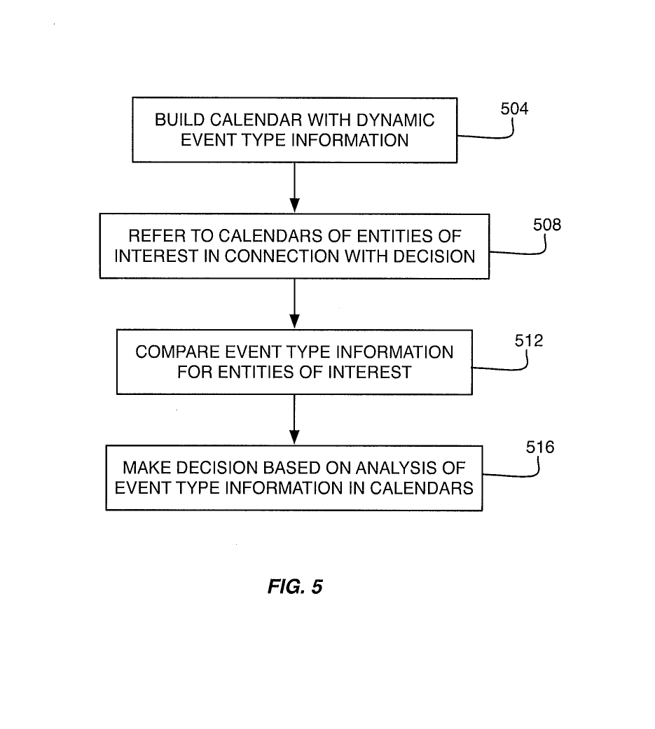

With reference now to FIG. 5, additional details of a method for utilizing the rich calendar information 208 in connection with the execution of a strategy rule in a contact center will be described in accordance with embodiments of the present disclosure. The method begins with the scheduling module 124 building rich calendar information 208 for entities of interest, where the rich calendar information 208 includes dynamic event type information in the form of values assigned based on event types (step 504). In other embodiments, the rich calendar information 208 may already have been built and the scheduling module 124 and/or work assignment engine 120 may obtain the desired calendars 208 for each entity involved in the decision.

The method continues with the work assignment engine 120 analyzing time segments of interest in connection with the execution of the strategy rule (step 508). Specifically, if a work assignment decision is being made for time=T, then the work assignment engine 120 may analyze (or use the scheduling module 124 to analyze) the time segment T for each entity's calendar information 208. In some embodiments, the analysis may include comparing the event type values in each of the corresponding segments to determine the best entity or entities to select in connection with making the decision (step 512). As a non-limiting example, the work assignment engine 120 may analyze a common time segment for five resources 112 and compare the values in each time segment of each resource with the values of the other resources. The work assignment engine, based on this comparison, may determine that a first of the five resources 112 has a value that best satisfies the decision criteria. Thus, the work assignment engine 120 is configured to make a decision that includes a consideration of each entity's calendar and a comparison thereof (step 516).

A helpful, but non-limiting, example of such a decision may include deciding whether a work item should be routed to a first, second, or third resource at time=T. The work assignment engine 120 may analyze cost values for each resource in the time segment corresponding to time=T. The resource with the lowest value in the time segment under consideration may be considered the most cost-effective choice to receive the work item. Of course, the consideration of calendar information may supplement other considerations made by the work assignment engine 120, such as skill, proficiency, customer history information, etc. The present disclosure simply provides a mechanism for incorporating calendar information into a work item routing decision made by a work assignment engine 120, for example.

While embodiments described herein were primarily directed toward a contact center implementation, it should be appreciated that the present invention is not so limited. Instead, the utilization of rich calendar information 208 may be useful in other environments such as workforce optimization, staffing, and other optimization scenarios.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving calendar description information for a first entity's calendar;
segmenting the first entity's calendar into a plurality of segments including a first time segment and a second time segment, wherein the plurality of segments span a calendar window;
identifying a first event in the first time segment;
determining a first value for the first event;
building a rich calendar for the first entity that includes each of the plurality of segments and the first value stored in association with the first time segment; and
storing the rich calendar for the first entity in a non-transitory computer-readable memory.

2. The method of claim 1, wherein the first value comprises a multi-bit vector.

3. The method of claim 2, wherein the multi-bit vector describes at least one of a cost associated with selecting the first entity during the first time segment and a perceived revenue associated with selecting the first entity during the first time segment.

4. The method of claim 1, wherein an amount of time covered by each time segment in the plurality of time segments equals a predetermined amount of time.

5. The method of claim 1, further comprising:
receiving calendar description information for a second entity's calendar;
segmenting the second entity's calendar into the plurality of segments including the first time segment and the second time segment, wherein the plurality of segments span the calendar window;
identifying a second event in the first time segment of the second entity's calendar;
determining a second value for the second event;
building a rich calendar for the second entity that includes each of the plurality of segments and the second value stored in association with the first time segment of the second entity's rich calendar; and
storing the rich calendar for the second entity in the non-transitory computer-readable memory.

6. The method of claim 5, further comprising:
executing a strategy rule;
determining, during execution of the strategy rule, that the first value satisfies the strategy rule better than the second value; and
selecting, as part of executing the strategy rule, the first entity instead of the second entity.

7. The method of claim 8, wherein the strategy rule comprises a work item routing decision, wherein the first entity corresponds to a first contact center agent, wherein the second entity corresponds to a second contact center agent, and wherein the first value indicates that the first agent is a better choice for receiving a work item as compared to the second entity based on a comparison of the first value and second value.

8. The method of claim 1, wherein the first entity comprises at least one of a contact center work item, a contact center resource, a contact center service, and a contact center site.

9. The method of claim 1, wherein the first event corresponds to a lack of an event in the first time segment and wherein the first value indicates a cost associated with assigning a work item to the first entity during the first time segment.

10. The method of claim 9, wherein the first value corresponds to a lowest possible cost value.

11. A non-transitory computer readable medium having stored thereon instructions that cause a computing system to execute a method, the instructions comprising:
instructions configured to receive calendar description information for a first entity's calendar;
instructions configured to segment the first entity's calendar into a plurality of segments including a first time segment and a second time segment, wherein the plurality of segments span a calendar window;
instructions configured to identify a first event in the first time segment;
instructions configured to determine a first value for the first event;
instructions configured to build a rich calendar for the first entity that includes each of the plurality of segments and the first value stored in association with the first time segment; and
instructions configured to store the rich calendar for the first entity in a non-transitory computer-readable memory

12. The computer readable medium of claim 11, wherein the first value comprises a multi-bit vector.

13. The computer readable medium of claim 12, wherein the multi-bit vector describes at least one of a cost associated with selecting the first entity during the first time segment and a perceived revenue associated with selecting the first entity during the first time segment.

14. The computer readable medium of claim 11, wherein an amount of time covered by each time segment in the plurality of time segments equals a predetermined amount of time.

15. The computer readable medium of claim 11, the instructions further comprising:
instructions configured to receive calendar description information for a second entity's calendar;
instructions configured to segment the second entity's calendar into the plurality of segments including the first time segment and the second time segment, wherein the plurality of segments span the calendar window;
instructions configured to identify a second event in the first time segment of the second entity's calendar;
instructions configured to determine a second value for the second event;
instructions configured to build a rich calendar for the second entity that includes each of the plurality of segments and the second value stored in association with the first time segment of the second entity's rich calendar; and
instructions configured to store the rich calendar for the second entity in the non-transitory computer-readable memory.

16. The computer readable medium of claim 15, the instructions further comprising:
instructions configured to execute a strategy rule;
instructions configured to determine, during execution of the strategy rule, that the first value satisfies the strategy rule better than the second value; and
instructions configured to select, as part of executing the strategy rule, the first entity instead of the second entity.

17. The computer readable medium of claim 16, wherein the strategy rule comprises a work item routing decision, wherein the first entity corresponds to a first contact center agent, wherein the second entity corresponds to a second contact center agent, and wherein the first value indicates that the first agent is a better choice for receiving a work item as compared to the second entity based on a comparison of the first value and second value.

18. The computer readable medium of claim 11, wherein the first entity comprises at least one of a contact center work item, a contact center resource, a contact center service, and a contact center site.

19. A contact center, comprising:
a work assignment engine configured to execute one or more strategy rules that, as a part of execution, include an analysis of a first entity's schedule; and
a scheduling module configured to build a rich calendar information for the first entity based on the first entity's textual schedule thereby, the rich calendar information comprising one or more values assigned to a calendar segment that represent at least one of a cost and expected benefit associated with selecting the first entity in the calendar segment as part of the execution of the one or more strategy rules.

20. The contact center of claim 19, wherein the one or more values comprise a multi-bit vector which describes at least one of a cost and expected benefit associated with routing a work item to the first entity during the calendar segment.
